(19) United States
(12) Patent Application Publication
(10) Pub. No.: US 2004/0198583 A1
(43) Pub. Date: Oct. 7, 2004

(54) Hearth covering agent for carbonization chamber of coke oven, method for production thereof and method for application thereof on hearth

(76) Inventors: Takeshi Ando, Tokyo (JP); Tadakatsu Kishi, Tokyo (JP); Ryuzou Wakimoto, Tokyo (JP); Teruo Onozawa, Kanagawa (JP); Shigeru Nakai, Kanagawa (JP)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/484,933

(22) PCT Filed: Feb. 20, 2003
(86) PCT No.: PCT/JP03/01835

(30) Foreign Application Priority Data
Feb. 22, 2002 (JP) 2002-46510

(51) Int. Cl. C04B 35/48; C04B 35/49

(52) U.S. Cl. 501/106; 501/107

(57) ABSTRACT

The present invention relates to a sole-covering agent for use in a carbonization chamber of a coke oven wherein the agent includes a refractory material having an average particle diameter of 10 μm or less and a melting point higher than a wall surface temperature of a carbonization chamber during operation and an organic binder and the agent has an average particle diameter in the range of from 0.3 to 10 mm, and a method of manufacturing the same. Furthermore, a method of applying the sole-covering agent to a coke oven is also provided. According to the invention, a load generated after coating of a high temperature refractory material for use in a carbonization chamber of an oven wall and applied on a coke pushing machine can be reduced.

### TECHNICAL FIELD

The present invention relates to a covering agent that covers a sole of a carbonization chamber of a coke oven and a manufacturing method thereof and an applying method thereof to the sole.

### BACKGROUND ART

A coke oven has a configuration in which a carbonization chamber in which coal is dried by distillation to obtain coke and a combustion chamber where a fuel gas is burned for heating are many times alternately arranged. A carbonization chamber of a general coke oven is a rectangular cavity having a height of substantially from 6 to 7 m, a depth of substantially from 15 to 16 m and a width of substantially from 0.4 to 0.5 m. Furthermore, in order to easily push out the coke outside of the oven, a width is slightly widened toward a coke exhaust side. Coal that is a raw material is supplied in a coal carrier from a charging inlet disposed on a ceiling side of the carbonization chamber and leveled to a uniform height with a leveler belonging to a coke pushing machine. Thereafter, the coal is heated from combustion chambers on both side of the carbonization chamber through a separating wall and thereby dried by distillation. After the dry distillation comes to completion, doors on both the exhaust and pushing machine sides are opened, the coke is pushed out of a coke exhaust outlet on an opposite side by means of the pushing machine. The exhausted coke is quenched and cooled by a quenched and thereby a product, coke, is obtained.

In the process of forming coke, a tar component in the coal is gasified and refractory bricks that constitute the carbonization chamber are also exposed to a severe high temperature condition. In recent years, in order to increase coke strength, the coal, before being charged into the oven, is dried to reduce a moisture component that is ordinarily from 8 to 12% to from 5 to 6%, and thereby a pretreatment to increase a bulk density of the coal is performed.

In the separating wall that partitions the carbonization chamber and the combustion chamber, silica refractory bricks are generally used. The silica refractory brick is generally manufactured in such a manner in that silica raw material is pulverized, mingled with water followed by charging in a frame and dried, further followed by sintering at substantially 1200 degree centigrade. The silica refractory brick, in order to increase the heat insulating properties, has high porosity and is formed through inter-particle contact. Accordingly, it is destined to be easily peeled or worn owing to friction and so on. In general, a coke oven formed with the silica refractory bricks, after drying the carbonization chamber at a uniform temperature to remove stress of the bricks, is operated.

A brick surface of a wall surface of the carbonization chamber that was smooth at an early stage of furnace application is gradually roughened by peeling or cracking owing to friction with charged coal and coke and frequent repetition of heating and cooling. Since the roughened surface is further increased in the friction resistance, coal being processed, coke or carbon or ash that is generated owing to the combustion tends the more to adhere resulting in a surface having the remarkable irregularity. As a result, the pushing resistance of the coke increases, load on a coke pushing machine increases, resulting in a serious problem in operating the coke oven. Furthermore, when a portion called a joint that fills a gap between the bricks is damaged owing to forcible pushing, raw gas generated by the dry distillation flows through the gap of the separating wall into the combustion chamber and causes incomplete combustion, resulting in causing exhausting black smoke.

In order to inhibit carbon from adhering the refractory bricks in the carbonization chamber, JP-A No. 59-174585 discloses means for coating a surface protective material made of high temperature refractory material to the refractory bricks followed by heating. Furthermore, JP-A No. 63-236783 discloses means for using refractory bricks on which in a green body stage a surface protective material is coated. Still furthermore, the present applicant discloses in JP-A No. 8-119775 a high temperature refractory material that by increasing the purity of silica in a particular component can form a strong and smooth surface layer.

Furthermore, JP-A. No. 9-125068 proposes apparatus that coats a surface protective material on refractory bricks of a wall surface of a carbonization chamber. The apparatus is disposed on a coke pushing machine side of the carbonization chamber and includes a bogie moving back and forth from the outside of the oven to a length direction of the carbonization chamber; a horizontal lance that is attached to a back end portion of the moving bogie and has a function movable back and forth horizontally, at a lower portion of the carbonization chamber, in a length direction from one end to the other end; a vertical lance erected at a tip end portion of the horizontal lance in a height direction of the carbonization chamber; and spray nozzles for coating a refractory material disposed in a multi-stage along a height direction of the vertical lance so as to face a wall surface of the carbonization chamber.

According to the apparatus, a smooth surface protective layer can be surely formed on a brick surface of an oven wall of a side surface of a carbonization chamber. However, in actuality, some surface protective material may collide with the brick surface of the oven wall and may be bounced and scattered (hereinafter referred to also as “rebound”). These are accumulated on a sole portion of the carbonization chamber, heated by the temperature of the carbonization chamber and hardened, and project as a superfluous surface layer. When this happens, these are in a way of the coke being pushed out, resulting in a large load on the coke pushing machine.

In order to inhibit a refractory material for a wall surface of a sole portion of a carbonization chamber from being accumulated, the present applicant has proposed a method of coating a high temperature refractory material and apparatus that are described in JP-A No. 10-46153. The method is an invention accomplished based on relationship between viscosity rise of the high temperature refractory material and load characteristics of the coke pushing machine. That is, according to this method, from the viscosity of the high temperature refractory material, a coating amount thereof per unit area is set so that the pushing load may be a predetermined value or less. According to the method, coating irregularity or hanging of the refractory material for use in wall surface, or loss due to rebound is intended to suppress. On the other hand, the apparatus is characterized in that, as shown in FIG. 1, below spray nozzles 12 for coating a refractory material disposed in a multi-stage so as to face the wall surface of the carbonization chamber along a height direction of the vertical lance 11, a receiver 33 of the high temperature refractory material is disposed so as to cover a lower portion of the carbonization chamber in a width direction and go back and forth together with at least the spray nozzles. The receiver receives the refractory material for wall surface that is scattered owing to the rebound at the blowing, and thereby inhibiting it from re-adhering.

However, even when the coating method of a high temperature refractory material and the apparatus that are described in the JP-A No. 10-46153 are used, the high temperature refractory material cannot be completely inhibited from falling on the sole of the carbonization chamber of a coke oven.

This is because among the falling rebounds, ones falling from an upper portion than the receiving portion can be captured; however, leakage of the rebounds from the gaps (left and right in a lance moving direction) between the receiving portion and the bricks of the carbonization chamber and the rebounds that fall before (during forwarding) or behind (at retreating) the receiver that moves together with the lance cannot be captured. These rebounds that are not captured adhere the sole bricks and solidify, resulting in the resistance during the pushing out.

Furthermore, the present inventors have proposed in JP-A No. 2002-69457 spraying apparatus of a sole-covering agent as a method that does not allow the high temperature refractory material that falls on the sole to adhere the sole bricks and solidify. In the apparatus according to the above invention, primary particles having an average particle diameter of substantially 5 μm are used without modification as a sole-covering agent; accordingly, dust generation at spraying thereof in the carbonization chamber is vigorous, and when coal is charged into the carbonization chamber blowing up of inner air scatters the sole-covering agent, in some cases resulting in incapability of exhibiting an effect of the sole covering.

The present invention is performed to overcome the above problems and intends to provide a sole-covering agent for use in a carbonization chamber of a coke oven that can be easily removed even when the high temperature refractory material for use in the wall surface of the sole of the carbonization chamber of the coke oven fall, and a manufacturing method thereof and an applying method thereof.

### DISCLOSURE OF INVENTION

That is, the present invention is a sole-covering agent for a carbonization chamber of a coke oven wherein the agent includes a refractory material having an average particle diameter of 10 μm or less and a melting point higher than a wall surface temperature of a carbonization chamber at the time of operation and an organic binder and the agent has an average particle diameter in the range of from 0.3 to 10 mm.

In the sole-covering agent, the refractory material preferably contains 40% by volume or more of zirconium silicate. Among these, the refractory material more preferably contains zirconium silicate and alumina, respectively, in the range of from 40:60 to 70:30 by volume ratio.

Furthermore, in all of the sole-covering agents, the organic binder is preferably at least one kind selected from a group of polyvinyl alcohols, polymers of vinyl alcohol derivatives and polysaccharides.

Still furthermore, the present application provides also a manufacturing method of a sole-covering agent for use in a carbonization chamber of a coke oven in which to a refractory material having an average particle diameter of 10 μm or less and having a melting point higher than a wall surface temperature of the carbonization chamber at operation an organic binder is added followed by granulating into an average particle diameter in the range of from 0.3 to 10 mm.

In the method of manufacturing the sole-covering agent, it is preferably granulated with an aqueous liquid of an organic binder adding by spraying.

Furthermore, in all of the above manufacturing methods, the organic binder is preferably at least one kind selected from a group of polyvinyl alcohols, polymers of vinyl alcohol derivatives and polysaccharides.

Still furthermore, in the present application, an application method is also provided in which before coating a refractory material for use in wall surface on a wall surface of a carbonization chamber of a coke oven, the sole surface of the carbonization chamber is covered with a sole-covering agent that includes a refractory material having an average particle diameter of 10 μm or less and a melting point higher than a wall surface temperature of the carbonization chamber at the time of operation and an organic binder and has an average particle diameter in the range of from 0.3 to 10 mm.

In the application method, an entire surface of the sole surface is preferably covered with the sole-covering agent.

Furthermore, in the application method, in an area where the refractory material for use in wall surface is expected to rebound at the coating of the refractory material for use in wall surface, the sole-covering agent is preferably coated previously.

All of the above application methods are preferably performed under an operation temperature before transferring coal for coke manufacturing in the carbonization chamber.

### BRIEF DESCRIPTION OF THE DRAWINGS

FIG. 1 is a schematic constitutional diagram of a coating machine of a high temperature refractory material for coating a high temperature refractory material to a wall surface of a carbonization chamber of a conventional coke oven.

FIG. 2 is a schematic constitutional diagram of a covering machine of a sole-covering agent showing one embodiment according to the present invention.

FIG. 3 is an explanatory diagram of an operation of the sole-covering agent.

FIG. 4 is a schematic constitutional diagram of a coating machine of a high temperature refractory material that concurrently works as a covering apparatus of a sole-covering agent showing another embodiment according to the invention.

### BEST MODE FOR CARRYING OUT THE INVENTION

In the following, the present invention will be more detailed.

The present invention is a sole-covering agent for use in a carbonization chamber of a coke oven wherein the agent includes a refractory material having an average particle diameter of 10 μm or less and a melting point higher than a wall surface temperature of a carbonization chamber at the time of operation and an organic binder and the agent has an average particle diameter in the range of from 0.3 to 10 mm.

The “particle diameter” in the invention means, as far as not particularly mentioned, an average particle diameter. The average particle diameter can be measured according to, for instance, laser diffractometry or micrography.

An average particle diameter of the refractory material constituting a sole-covering agent according to the invention is set at 10 μm or less. In the case of the average particle diameter being large and exceeding 10 μm, when secondary particles are granulated, since the granulation proceeds with the larger particles as nucleuses, not spherical but irregularly shaped secondary particles are produced a lot, resulting in a decrease in the yield of ones in the provided particle size range.

Ordinarily, as the refractory material, pulverized ones are used; accordingly, these are not necessarily spherical. Furthermore, ordinarily, there may be formed secondary particles or tertiary particles owing to the aggregation. In the present application, the primary particles are approximated to spheres and an average particle diameter thereof is used to define. The refractory material preferably has an average particle diameter in the range of from 2 to 8 μm and a particle size distribution in the range of from 0.1 to 10 μm, and more preferably an average particle diameter in the range of from 3 to 4 μm and a particle size distribution in the range of from 2 to 5 μm.

The sole-covering agent according to the invention captures the high temperature refractory material for use in the carbonization chamber sidewall that falls on the sole owing to the rebound and exhausts outside simultaneously with pushing out of coke. Accordingly, the refractory material having an average particle diameter of 10 μm or less that constitutes the sole-covering agent must not melt at a wall surface temperature of the carbonization chamber at the time of operation of the coke oven. Accordingly, the melting point of the refractory material is necessary to be higher than a wall surface temperature of the carbonization chamber at the operation of the coke oven. “At the time of operation” in “the wall surface temperature at the time of operation of the coke oven” indicates a continuous process operation state having the regularity accompanying a coke manufacturing operation. An irregular operation time such as that stops partially or wholly the operation for regular services or repairing is not intended. Furthermore, the “wall surface temperature of the carbonization chamber” means a surface temperature of a sidewall surface of the carbonization chamber. More specifically, it indicates a surface temperature of the refractory bricks that constitute the sidewall surface in the carbonization chamber during from after pushing out the coke up to before charging raw coal. This temperature can be usually monitored with a radiation thermometer and so on and is generally from substantially 900 to 1000 degree centigrade. At least, it does not mean a temperature in the neighborhood of room temperature that allows an operator to work.

As the refractory materials constituting the sole-covering agent, oxides such as zirconium silicate (ZrO₂ SiO₂, ZrSiO₄), silica (SiO₂), alumina (Al₂O₃) and so on can be illustrated. Among these, zirconium silicate is particularly preferable. The zirconium silicate is a primary component of an ore that naturally exists as zircon, such small in the thermal expansion coefficient as 4.9×10⁻⁶, does not exhibit the anomalous expansion like zirconium oxide, has the melting point of 2400 degree centigrade or more and is excellent in the heat resistance, and can endure even an abrupt temperature change. Accordingly, it is preferable to combine silica (called also as silica sand) and alumina as other materials with zirconium silicate as a primary component. Since an object of the sole-covering agent is to inhibit the high temperature refractory material for use in oven wall from melting or fusing with the sole, the refractory material itself that constitutes the sole-covering agent is preferable not to melt or fuse with the high temperature refractory material for use in the oven wall. The difficulty of such melting or fusing follows an order of the highness of the melting point of the refractory material constituting the sole-covering agent, being advantageous in the order of zirconium silicate>alumina>silica. Accordingly, when combining these, zirconium silicate and alumina can be preferably combined. As a result of various experiments, in the case of zirconium silicate being contained by 40% by volume or more, even when the high temperature refractory material for use in oven wall has fallen on the sole-covering agent, the high temperature refractory material for use in oven wall becomes difficult to melt or fuse with the sole, resulting in preferably reducing the load at the time of pushing out coke. Accordingly, in the sole-covering agent according to the invention, the refractory material preferably contains 40% by volume or more of zirconium silicate. However, zirconium silicate is more expensive than other materials; accordingly, as the other component, the silica or alumina can be preferably combined. As combinations that are economical and can reduce the load at the time of pushing out coke, ones in which the refractory material contains zirconium silicate and alumina, respectively, in the range of from 40:60 to 70:30 by volume ratio can be cited. In this case, a total of both volume ratios is preferably 100.

In the invention, an organic binder is added to the refractory material that satisfies the above conditions, followed by granulating into granules having an average particle diameter of from 0.3 to 10 mm, and thereby the sole-covering agent is obtained. Such organic binder, as far as it can bind or adhere the refractory material in the neighborhood of room temperature is not particularly questioned of the kind or an amount being used. It is because under temperature conditions during an ordinary coke oven operation where the present sole-covering agent exhibits an operation, almost of the organic binder is decomposed or evaporated. Organic polymers having ordinary adherence and binding properties can be preferably used. When an ordinary amount that is used of the organic binder is shown just for reference, it is in the range of substantially from 1 to 5% by weight of the sole-covering agent. As such organic binder, at least one kind selected from a group of polyvinyl alcohols, polymers of vinyl alcohol derivatives and polysaccharides can be cited. Among these, polysaccharides such as starch, methyl cellulose, carboxylmethyl cellulose and so on, polyvinyl acetate, polyvinyl alcohol and so on are preferable.

An average particle diameter of the sole-covering agent according to the invention is in the range of from 0.3 to 10 mm. The sole-covering agent captures the high temperature refractory material for use in the oven wall that rebounds and falls on the sole and is exhausted outside together with coke in the process of pushing out coke. Accordingly, since the capturing effect is the better as gaps between granules of the sole-covering agent are the smaller, the particle diameter of the sole-covering agent is set at 1 mm or less. When an average particle diameter of the covering agent exceeds 10 mm, the covering agent can be uniformly sprayed with difficulty. The average particle diameter of the covering agent is preferably 5 mm or less and more preferably 1 mm or less. However, since the carbonization chamber becomes a slender opening after the coke is pushed out, when the average particle diameter of the sole-covering agent is less than 0.3 mm, wind that goes through the carbonization chamber generates dust. Accordingly, the particle diameter of the sole-covering agent is set at 0.3 mm or more and preferably at 0.5 mm or more.

The sole-covering agent according to the invention, as far as the above conditions are satisfied, can sufficiently exhibit the effect thereof. However, it does not exclude to further contain other components. As such other component, not only inevitable impurities but also a lubricating material and so on can be positively contained.

Furthermore, the sole-covering agent having an average particle diameter of from 0.3 to 10 mm according to the invention, immediately after the manufacture thereof, can be crushed with a force to the extent of human fingertips. However, when it is applied to the sole of the carbonization chamber and used, it solidifies owing to the firing and forms a solid granular matter. Accordingly, when a force is applied from a sideward direction with a pushing machine, an effect of rolling or sliding is exhibited, and thereby the sole-covering agent is removed together with the high temperature refractory material for use in the oven wall. Accordingly, as the sole-covering agent according to the invention, ones that are previously sintered outside of the coke oven can be used. The sintered sole-covering agent, even when crushed, since an average particle diameter of the high temperature refractory material constituting the sole-covering agent is such small as 10 μm or less, enters the gaps between the sole bricks and can exhibit a sliding effect at the time of pushing out coke.

In the present application, a method of manufacturing a sole-covering agent for use in a carbonization chamber of a coke oven is also provided in which an organic binder is added to a refractory material having an average particle diameter of 10 μm or less and a melting point higher than a wall surface temperature of the carbonization chamber during the operation followed by granulating into granules having an average particle diameter of from 0.3 to 10 mm.

Necessary conditions on the raw materials that are used in the present manufacturing method and the sole-covering agent that is a product are as mentioned above.

In the manufacturing method, granulating means are not questioned. Ordinarily, an organic binder is added to the refractory material followed by granulating in an average particle diameter of from 0.3 to 10 mm by means of a granulating machine, and thereby a sole-covering agent for use in the carbonization chamber of a coke oven is manufactured. As such a granulating machine, a pelletizer or a drum revolution type granulating machine can be cited. Furthermore, the organic binder may be added as it is or one that is dissolved or dispersed in a medium may be added. The granulation can be applied after the organic binder is added to the refractory material. Alternatively, while adding the organic binder to the refractory material that is being rolled with a granulating machine, the granulation can be performed. Preferably, with the refractory material rolling by use of a granulating machine and an aqueous liquid of the organic binder spraying thereto, the granulation is performed. The aqueous liquid of an organic binder means an aqueous solution of the organic binder, an aqueous dispersion thereof or both thereof. A concentration of the organic binder contained in the aqueous liquid is not particularly restricted. Preferably, it is from substantially 1 to 5% by weight.

Operation conditions of the granulating machine, being different depending on models of machine, cannot be clearly provided. In effect, it is only necessary that the sole-covering agent for use in the carbonization chamber of the coke oven having an average particle diameter of from 0.3 to 10 mm can be manufactured. Even when the sole-covering agent exceeding 10 mm in the average particle diameter or that smaller than 0.3 mm in the average particle diameter is produced as a by-product, these can be selected by sieving. When an improvement in the yield is intended, an example in which by use of, for instance, a drum granulating machine, the granulation is performed under the conditions of a rolling speed of from 20 to 60 revolutions per minute, a temperature from 10 to 40 degree centigrade, and a rolling time of from 0.5 to 1 hr can be preferably cited.

In the present application, an applying method is also provided in which before a refractory material for use in wall surface is coated on a wall surface of a carbonization chamber of a coke oven, a sole surface of the carbonization chamber is covered with a sole-covering agent that contains a refractory material having an average particle diameter of 10 μm or less and a melting point higher than a wall surface temperature of the carbonization chamber during the operation and an organic binder and has an average particle diameter of from 0.3 to 10 mm.

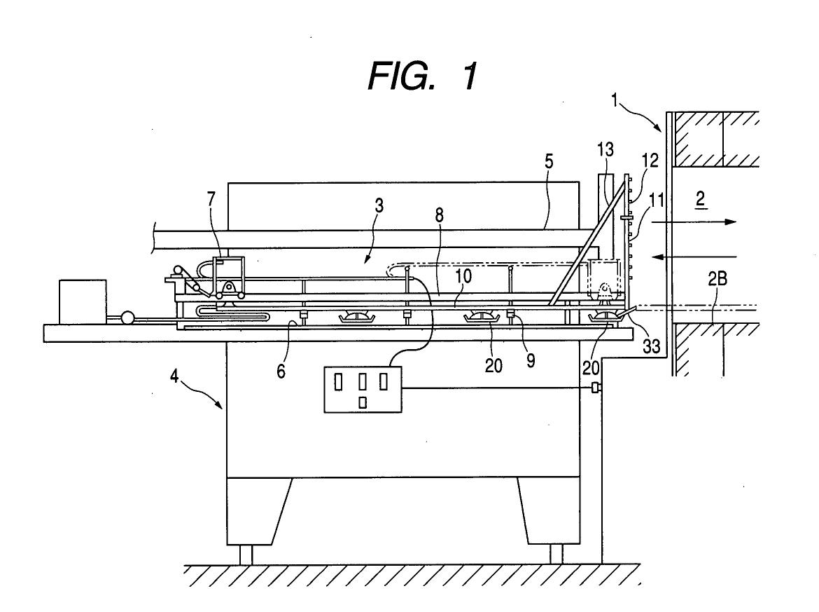

FIG. 1 shows a coating machine of a high temperature refractory material for use in wall surface of a carbonization chamber of a coke oven described in JP-A No. 10-46153. In FIG. 1, reference numerals 1, 2 and 2B, respectively, are a coke oven, a carbonization chamber and a sole of the carbonization chamber. Reference numeral 3 denotes a coating machine of a high temperature refractory material, reference numeral 4 a pushing machine, reference numeral 5 a coke pushing ram, reference numeral 6 a working floor, reference numeral 7 a moving bogie, reference numeral 8 a fixed guide rail, reference numeral 9 a carrier roll, reference numeral 10 a horizontal lance, reference numeral 11 a vertical lance, reference numeral 12 a spray nozzle for coating a high temperature refractory material, reference numeral 13 a sloped exhaust tube, reference numeral 20, a sliding shoe, and reference numeral 33 a receiver. The spray nozzles 12 for coating a high temperature refractory material are disposed on both sides of the vertical lance 11 respectively in a multi-stage facing an oven wall of the carbonization chamber 2.

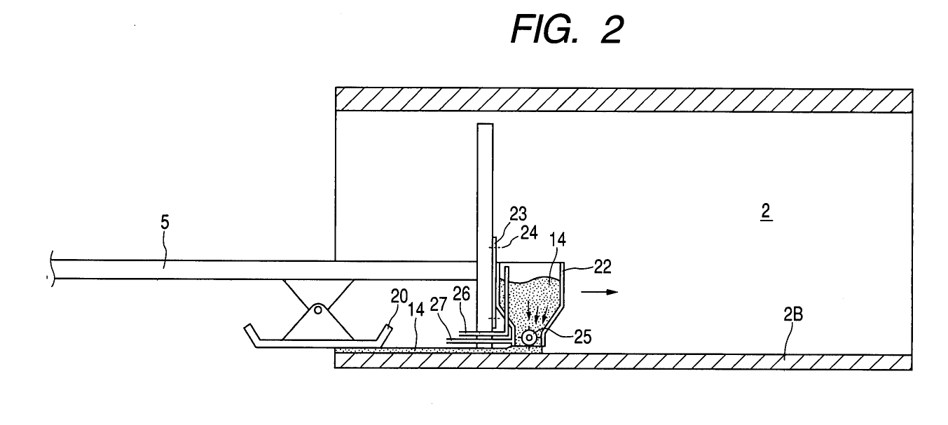

On the other hand, FIG. 2 shows an example of a covering machine of a sole-covering agent by which, before the high temperature refractory material is coated on an oven wall of the carbonization chamber by use of a coating machine of a high temperature refractory material, a sole 2B of the carbonization chamber 2 is covered with a sole-covering agent for use in a carbonization chamber of a coke oven according to the invention.

In FIG. 2, the reference numeral 20 shows the slide shoe disposed below a tip end of the coke pushing ram 5. The covering machine of a sole-covering agent is provided with a hopper 22 below a tip end of the coke pushing ram 5. Inside of the hopper 22, a covering agent 14 for covering a sole is reserved, and at an internal bottom thereof a rotary feeder 25 is disposed to efficiently cut out the covering agent 14. A side plate 23 of the hopper 22 is fixed to a tip end of the coke pushing ram 5 with a bolt 24. As described later, since the covering of the sole with the covering agent 14 by use of the hopper 22 is performed while the carbonization chamber 2 is still in a high temperature state, an external wall of the hopper 22 is structured in a double-jacket and inside thereof cooling water is flowed to cool. Reference numeral 26 in the drawing denotes a feed tube for feeding cooling water to the hopper 22, and reference numeral 27 denotes an exhaust tube for recovering the cooling water. Accordingly, when, with the rotary feeder 25 rotating, the coke pushing ram 25 is driven so as to move the hopper 22 at a predetermined speed from one end of the carbonization chamber 2 to the other end thereof, an entire surface of the sole of the carbonization chamber 2 can be uniformly covered with the covering agent 14.

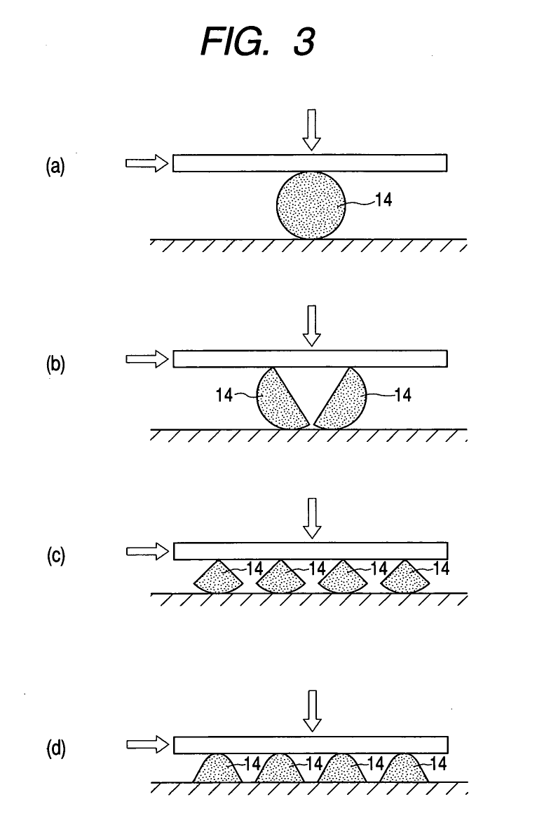

Furthermore, since the sole-covering agent 14 is formed into granules by granulating a refractory material of 10 μm or less, there are following effects. That is, FIG. 3 shows changes in shape when at an upper portion of the sole-covering agent 14 a force is downwardly and sidewardly applied. The force from above is a weight of coke piled up on the covering agent 14 that covers the sole of the carbonization chamber 2, and a sideward force is a pushing force applied when the coke is pushed out. When the upper portion of the sole-covering agent is subjected to a force from the above and a sideward force, as shown in FIGS. 3a through 3d with time, the sole-covering agent 14 collapses and becomes an original fine particle state, that is, a refractory material of 10 μm or less, this exhibits a sliding effect and reduces the load at the pushing out of the coke, and the pulverized sole-covering agents 14 enter fine pores of the sole bricks and thereby further reducing the load when the coke is pushed out.

Furthermore, an application method according to the invention is preferably one in which an entire surface of the sole surface is covered with the sole-covering agent.

That is, in this embodiment, in a carbonization chamber of a coke oven that is still in a high temperature after the pushing-out of the coke, first by use of the covering machine of sole-covering agent shown in the FIG. 2, on an entire surface of a sole of the carbonization chamber, the sole-covering agent 14 is sprayed with a substantially uniform thickness. An amount of used sole-covering agent 14 was substantially 60 kg for a sole area of 6.75 m² of a carbonization chamber having, for instance, a length of 15 m, a height of 6.5 m and a width of 0.45 m. That is, substantially 8.9 kg/m² per unit area is enough to use.

Thereafter, when by use of the coating machine of a high temperature refractory material shown in FIG. 1, the high temperature refractory material is coated on a top surface and both side surfaces of the carbonization chamber, the high temperature refractory material melts on a high temperature oven wall, adheres as it is, and thereby forms a coating layer that is smooth and high in the strength as mentioned above. Furthermore, at this time, even when the high temperature refractory material for use in oven wall falls because of the rebound, it falls on the sole-covering agent 14. Accordingly, even when the operation of the coke oven is started as it is, the high temperature refractory material for use in oven wall does not directly melt and fuse with the sole.

Thereafter, in the carbonization chamber of the coke oven, a compounded coal is charged followed by drying by distillation at a predetermined temperature further followed by pushing out by use of the pushing machine 4. Thereby, the high temperature refractory material for use in wall surface captured on the sole-covering agent 14 is pushed out together with coke and exhausted outside. In the firstly pushed out coke, thus the sole-covering agent and the high temperature refractory material for wall surface fallen owing to the rebound are mingled. As mentioned above, since the sole-covering agent is also substantially 60 kg per one carbonization chamber having the above size in comparison with the coke of 20 tons level per one carbonization chamber, it does not adversely affect on quality. Accordingly, either application method according to the invention is preferably carried out under an operation temperature before coal for use in coke manufacture is charged in the carbonization chamber.

“Under the operation temperature” here means a temperature range of apparatus where one skilled in the art ordinarily maintains over the whole of the continuing operation state having the regularity accompanying the coke manufacturing operation. When it is expressed with, for instance, a surface temperature of the refractory bricks that constitute the sidewall surface of the carbonization chamber during from after the pushing out of the coke up to charge of raw coal, it is generally in the range of from substantially 900 to 1000 degree centigrade. This temperature can be ordinarily monitored with a radiation thermometer and so on.

Furthermore, in the present invention, an application method is also preferable in which, of the sole surface of the carbonization chamber of the coke oven, in an area where the refractory material for use in wall surface is inferred to rebound during the coating thereof, the sole-covering agent according to the present invention is coated in advance.

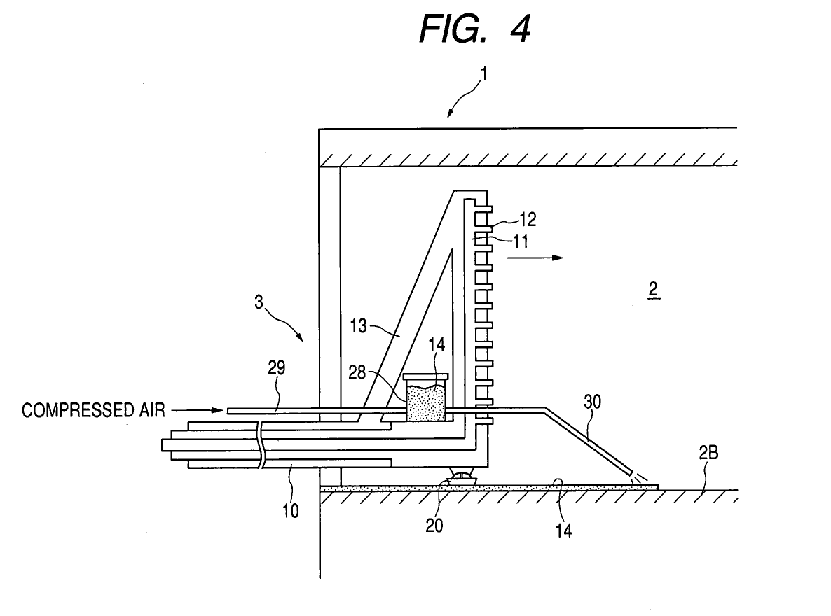

This application method will be explained with reference to FIG. 4. In this mode for carrying out the invention, the coating machine of a high temperature refractory material is concurrently provided with a function of the covering machine of sole-covering agent. In the apparatus, a housing 28 of a sole-covering agent 14 is disposed above a horizontal lance 10, and the sole-covering agent 14 accommodated in the housing 28 is compressed by a compressed air sent in a pressurizing tube 29 and ejected forward from an ejecting tube 30 projected forward from a vertical lance 11, and thereby it is sprayed on a sole 2B. In the present mode for carrying out the invention, a projection length from the vertical lance 11 of the ejecting tube 30 was set at substantially 3.5 m. That is, in the present mode, when, with the high temperature refractory material spraying from the spray nozzles 12 for coating the high temperature refractory material toward an oven wall of a carbonization chamber 2, the sole-covering agent 14 according to the present invention is ejected from the ejection tube 30, the sole 2B ahead in a proceeding direction of the apparatus that is, only an area before the high temperature refractory material for use in oven wall rebounding and falling, is covered with the sole-covering agent 14. Thereafter, the high temperature refractory material for use in oven wall rebounds and falls on the sole-covering agent 14 that covers the sole 2B. In this case also, the rebounded high temperature refractory material for use in oven wall falls on the sole-covering agent 14. Accordingly, when the coke oven is started to operate as it is, the high temperature refractory material for use in oven wall does not directly melt and fuse with the sole. Furthermore, in the mode for carrying out the invention, the coating of the high temperature refractory material for use in oven wall and covering of the sole with the sole-covering agent can be simultaneously performed; accordingly, efficiency is very good. In this case also, an amount of the sole-covering agent 14 used may be substantially 60 kg per one carbonization chamber of the above size.

As mentioned above, since an amount of the refractory material for use in sole that is mingled in the coke is slight in comparison with that of an obtained coke, it does not adversely affect on the quality of the coke.

Embodiment

High purity zirconium silicate sintered at a temperature in the range of from 1300 to 1600 degree centigrade is crushed by use of a vibration mill followed by classifying by use of a dry air classifier into an average particle diameter of 5 μm. On the other hand, aluminum hydroxide sintered at a temperature from 1000 to 1300 degree centigrade by use of a rotary kiln is crushed by use of a ball mill followed by classifying with a dry air classifier into an average particle diameter of 5 μm. Sixty percent by weight of crushed zirconium silicate and 40% by weight of crushed aluminum hydroxide are blended by use of a V blender. This mixture is thrown into a drum type rolling granulating machine and granulated with an aqueous liquid of from 2 to 5% starch spraying. Thereafter, it is sieved by use of a slope type sieve. Ones of 0.15 mm or less are returned once more to the drum type rolling granulating machine. Ones of 0.15 mm or more are dried by means of an air dryer followed by classifying, and thereby a sole-covering agent having an average particle diameter of 5 mm was obtained. The sole-covering agent is used in the above-mentioned application examples.

### INDUSTRIAL APPLICABILITY

According to the invention, the high temperature refractory material for use in wall surface of the carbonization chamber of a coke oven can be inhibited from accumulating and solidifying on the sole owing to the rebounding. Accordingly, the load applied on the coke pushing machine can be suppressed from increasing. Resultantly, the present invention can contribute to extending the lifetime of the coke oven and suppressing the consumption energy.

1. A sole-covering agent for use in a carbonization chamber of a coke oven wherein the agent includs a refractory material having an average particle diameter of 10 μm or less and a melting point higher than a wall surface temperature of a carbonization chamber during operation and an organic binder and the agent has an average particle diameter in the range of from 0.3 to 10 mm.

2. A sole-covering agent as set forth in claim 1 characterized in that the refractory material includes 40% by volume or more of zirconium silicate.

3. A sole-covering agent as set forth in claim 1 characterized in that the refractory material includes zirconium silicate and alumina, respectively, in the range of from 40:60 to 70:30 by a volume ratio.

4. A sole-covering agent as set forth in claim 1 characterized in that the organic binder is at least one kind selected from a group of polyvinyl alcohols, polymers of vinyl alcohol derivatives and polysaccharides.

5. A method of manufacturing a sole-covering agent for use in a carbonization chamber of a coke oven characterized by adding an organic binder to a refractory material having an average particle diameter of 10 μm or less and a melting point higher than a wall surface temperature of a carbonization chamber during operation followed by granulating into from 0.3 to 10 mm.

6. A method of manufacturing a sole-covering agent as set forth in claim 5 characterized by granulating with an aqueous liquid of an organic binder adding by spraying.

7. A method of manufacturing a sole-covering agent as set forth in claim 5 characterized in that the organic binder is at least one kind selected from a group of polyvinyl alcohols, polymers of vinyl alcohol derivatives and polysaccharides.

8. An application method of a sole covering agent characterized in that before a refractory material for use in wall surface is coated on a wall surface of a carbonization chamber of a coke oven, a sole surface of the carbonization chamber is covered with a sole-covering agent that includes a refractory material having an average particle diameter of 10 μm or less and a melting point higher than a wall surface temperature of a carbonization chamber during operation and an organic binder, and has an average particle diameter in the range of from 0.3 to 10 mm.

9. An application method as set forth in claim 8 characterized by covering an entire surface of the sole surface with the sole-covering agent.

10. An application method as set forth in claim 8 characterized in that, of the sole surface, an area where the refractory material for use in wall surface is suspected to rebound during coating of the refractory material for use in wall surface is covered in advance with the sole-covering agent.

11. An application method as set forth in claim 8 characterized by performing the application method, before charging coal for use in coke manufacture in the carbonization chamber, under an operation temperature.
